(19) United States
(12) Patent Application Publication
(10) Pub. No.: US 2026/0105836 A1
(43) Pub. Date: Apr. 16, 2026

(54) 360 DEGREE INFORMATION SYSTEM FOR A VEHICLE

(71) Applicant: Volvo Car Corporation, Gothenburg (SE)

(72) Inventors: Vishisht Dhingra, Göteborg (SE); Mohammad Subhi Mohammad ALQawasmeh, Göteborg (SE); Stefan Järvholm, Hålta (SE); Rubén Calvillo Portales, Göteborg (SE)

(21) Appl. No.: 18/917,590

(22) Filed: Oct. 16, 2024

(51) Int. Cl. G08G 1/0965; G01S 15/04; G01S 15/931; G08G 1/04; G08G 1/0967; G08G 1/16

(52) U.S. Cl. CPC G08G 1/0965; G01S 15/04; G01S 15/931; G08G 1/04; G08G 1/096725; G08G 1/167

(57) ABSTRACT

Various systems and methods are presented regarding utilizing technology onboard a first vehicle to analyze soundwaves present at the first vehicle to determine any of: (a) presence of a second vehicle in the vicinity of the first vehicle, (b) an operating condition of the second vehicle, (c) presence and operation of an emergency vehicle, and suchlike. In response to a determination of a second vehicle operating in the vicinity of the first vehicle, the operation of the first vehicle can be adjusted in accordance with the operation of the second vehicle. The soundwaves can be of any frequency, e.g., audible/inaudible to the human ear. The first vehicle can be operating in an autonomous, semi-autonomous, or non-autonomous manner. Further, failure of an onboard component can also be detected.

### TECHNICAL FIELD

This application relates to systems and techniques for utilizing soundwaves to determine location and operation of a vehicle.

### BACKGROUND

Contemporary vehicles are replete with cameras, sensors, and suchlike, to enable a vehicle to operate in an autonomous/semi-autonomous manner, as well as assisting an operator of the vehicle, e.g., alert a driver that the vehicle is potentially about to cross into an adjacent traffic lane, and suchlike. However, while the respective cameras, sensors, etc., have been incorporated into a vehicle infrastructure to address respective frequently and less frequently encountered (aka edge case) operational scenarios, the cameras, etc., may have operational blindspots regarding ability to provide 360° operational coverage for the vehicle. Further, the cameras and sensors may be expensive, and potentially complicated to analyze images and data captured from/generated by the sensors and cameras.

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented to enable detection of a second vehicle proximate to a first vehicle, wherein the proximity can be determined utilizing detecting soundwaves. Further, operation of one or more components located on the first vehicle can be monitored.

According to one or more embodiments, a system can be located onboard a first vehicle, and comprise at least one processor, and a memory coupled to the at least one processor and having instructions stored thereon, wherein, in response to the at least one processor executing the instructions, the instructions facilitate performance of operations, comprising: analyzing soundwaves captured by one or more receivers, wherein the one or more receivers are located onboard the first vehicle, and further, based on analysis of the soundwaves, identifying a second vehicle operating proximate to the first vehicle.

In a further embodiment, the system can be further configured to generate initial soundwaves, wherein the soundwaves captured at the one or more receivers are reflected soundwaves generated from the initial soundwaves reflecting off a surface of the second vehicle. wherein the initial soundwaves and reflected soundwaves are configured with an inaudible frequency.

In another embodiment, wherein, in the event of two or more receivers are located onboard the first vehicle, the operations can further comprise determining the presence of the second vehicle based on a first reflected soundwave captured at a first receiver, a second reflected soundwave captured at a second receiver, and an n^{th} reflected soundwave captured at an n^{th} receiver, and further triangulating the first reflected soundwave, the second reflected soundwave, and the n^{th} reflected soundwave.

In an embodiment, the soundwaves have an inaudible frequency and are generated by a transmitter located on the second vehicle. In another embodiment, the soundwaves have an audible frequency and are generated by a transmitter located on the second vehicle.

In an embodiment, the first vehicle can be operating autonomously while navigating a road. In a further embodiment, the operations can further comprise adjusting operation of the first vehicle in accordance with operation of the second vehicle. Further, the adjusted operation of the first vehicle can comprise at least one of accelerate, reduce velocity, stop, pullover to the side of the road, or change lane.

In a further embodiment, wherein the soundwaves can be included in a first set of soundwaves received at the one or more receivers, wherein the operations can further comprise: analyzing a second soundwave captured by the one or more receivers, determining the second soundwave is generated by a component operating on the first vehicle, further comparing the second soundwave with a previously recorded soundwave, wherein the previously recorded soundwave has an identified source component, and further, in the event of the second soundwave matches the previously recorded soundwave, identifying the second soundwave as being generated by the identified source component of the previously recorded soundwave.

In other embodiments, elements described in connection with the disclosed systems can be embodied in different forms such as computer-implemented methods, computer program products, or other forms. For example, in an embodiment, a computer-implemented method can be performed by a device operatively coupled to at least one processor and located on a first vehicle operating in an at least partially autonomous manner, analyzing, by the device, a first soundwave captured by one or more receivers located on the first vehicle, and based on analysis of the first soundwave, further determining, by the device, a second vehicle is operating proximate to the first vehicle

[symbol]

In another embodiment, the first soundwave captured at the one or more receivers is a reflected soundwave, the reflected soundwave is created by an initial soundwave reflected from a surface of the second vehicle located proximate to the first vehicle, and the initial soundwave is generated by a transmitter located on the first vehicle.

In another embodiment, the reflected soundwave can comprise an inaudible frequency. In a further embodiment, the first soundwave can be generated by a transmitter, wherein the transmitter can be located onboard the second vehicle. In another embodiment, the first soundwave can comprise an inaudible frequency.

In a further embodiment, the computer-implemented method can further comprise autonomously navigating, by the device, the first vehicle in accordance with operation of the second vehicle.

Further embodiments can include a computer program product comprising a computer readable storage medium having program instructions embodied therewith to enable detection of a proximate vehicle. The program instructions are executable by a processor located on a first vehicle, and can cause the processor to control transmission of a first soundwave, wherein the first soundwave is transmitted by a transmitter located onboard the first vehicle, and further analyze a second soundwave captured by a set of receivers located on the first vehicle, wherein the second soundwave captured at the set of receivers is a reflected soundwave, the reflected soundwave is created by reflection of the first soundwave reflected from a surface of the second vehicle located proximate to the first vehicle. The program instructions are further executable by the processor to cause the processor to, based on analysis of the second soundwave, determine a second vehicle is operating proximate to the first vehicle. In an embodiment, a frequency of the first soundwave is inaudible or audible to the human ear. In a further embodiment, the first vehicle is operating autonomously.

In a further embodiment, a first portion of the second soundwave can be received at a first receiver in the set of receivers, a second portion of the second soundwave can be received at a second receiver in the set of receivers, and an n^{th} portion of the second soundwave can be received at an n^{th} receiver in the set of receivers, and the program instructions can further cause the processor to determine location of the second vehicle based on at least one of frequency, wavelength, amplitude, waveform, signal pulsing, timing, timestamp, direction, signal strength, or phase of the first portion of the second soundwave, second portion of the second soundwave, and the n^{th} portion of the second soundwave.

An advantage of the one or more systems, computer-implemented methods and/or computer program products can be utilizing various systems and technologies located on a first vehicle to assist the first vehicle in determining location/motion of a second vehicle, and based thereon, enabling navigation of the first vehicle with reference to the location/motion of the second vehicle. Utilizing a soundwave generation and analysis system enables soundwaves captured/measured at the first vehicle to determine any of: (a) presence of a second vehicle in the vicinity of the first vehicle, (b) an operating condition of the second vehicle, (c) operating condition of a component onboard the first vehicle, and suchlike. In response to a determination of a second vehicle operating in the vicinity of the first vehicle, the operation of the first vehicle can be adjusted in accordance with the operation of the second vehicle, for example, improving the ability of the first vehicle to operate in an autonomous/semi-autonomous manner. The various embodiments further enable early detection of a component undergoing operational failure.

### DESCRIPTION OF THE DRAWINGS

One or more embodiments are described below in the Detailed Description section with reference to the following drawings.

FIGS. 1A and 1B present various systems/configurations for a first vehicle to determine location/motion of a second vehicle, in accordance with an embodiment.

FIGS. 2A and 2B presents schematics illustrating implementation of soundwaves by a first vehicle to determine proximity of a second vehicle, in accordance with an embodiment.

FIG. 3 presents a schematic illustrating implementation of soundwaves received at a first vehicle to determine proximity of a second vehicle, in accordance with an embodiment.

FIG. 4 presents a schematic illustrating implementation of soundwaves received at a first vehicle to determine proximity of a second vehicle, in accordance with an embodiment.

FIG. 5 presents a schematic illustrating capturing soundwaves by an onboard system to enable determination of a component/device potentially undergoing failure, in accordance with an embodiment.

FIG. 6 illustrates a flow diagram for a computer-implemented method for utilizing soundwaves to determine a position of a vehicle, in accordance with at least one embodiment.

FIG. 7 illustrates a flow diagram for a computer-implemented method for utilizing soundwaves to determine a position of a vehicle, in accordance with at least one embodiment.

FIG. 8 illustrates a flow diagram for a computer-implemented method for utilizing soundwaves to determine operation of a component/device on a vehicle, in accordance with at least one embodiment.

FIG. 9 illustrates a block flow diagram for a method utilizing soundwaves to determine location of a second vehicle relative to a first vehicle, in accordance with one or more embodiments presented herein.

FIG. 10 is a block diagram illustrating an example computing environment in which the various embodiments described herein can be implemented.

FIG. 11 is a block diagram illustrating an example computing environment with which the disclosed subject matter can interact, in accordance with an embodiment.

FIG. 12 presents a summary of SAE J3016, detailing respective functions and features during Levels 0-5 of driving automation (per June 2018).

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, Abstract, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

As used herein, “data” can comprise metadata. Further, ranges A-n are utilized herein to indicate a respective plurality of devices, components, signals etc., where n is any positive integer.

While a conventional vehicle may include an array of cameras and sensors configured/arranged on a vehicle, to provide 360°of sensing/information/data coverage, the cameras and sensors can suffer from operational/sensing blindspots. For example, a second vehicle may not be in a field of view of a camera onboard a first vehicle, such that while it is known from a siren/soundwaves that the second vehicle is an emergency vehicle (e.g., police car, fire engine, ambulance), it is not possible to detect the location/direction of the emergency vehicle. Also, given the respective blind spots of the cameras and sensors, the second vehicle may be in the blindspot. Further, unless a sensor is directly coupled to/measuring operation of an onboard component (e.g., an engine component), the ability of the cameras and sensors to detect/determine a potential fault condition of the component(s) is limited.

Per the various embodiments presented herein, operational blindspots are eradicated as a function of the ubiquitous nature of sound waves. In particular, the ability to utilize soundwaves (e.g., a siren soundwave) received at a first vehicle to triangulate a location of a second vehicle, even though visual contact with the second vehicle has not been established.

Further, advantage is taken of operational noise of a component, etc., on the first vehicle, and failure diagnostics (e.g., early stage of failure, undergoing failure, etc.) implemented therefrom. The presented embodiments may be less complex/lower cost compared with systems currently implemented to achieve similar functionality/driver assistance. For example, a conventional approach to detect another vehicle proximate to a first vehicle is the use of cameras, LIDAR systems, and suchlike. However, such functionality can be achieved by utilizing a system comprising a combination of transmitters (e.g., speakers) in conjunction with various receivers (e.g., microphones).

It is to be appreciated that for the sake of brevity, components, devices, systems, etc., that are described with regard to a first vehicle (e.g., vehicle 102) can have the same functionality as comparable components, devices, systems, etc., present onboard a second vehicle (e.g., vehicle 170A-n). Hence, a first component onboard the first vehicle can have the same functionality as a comparable component present onboard a second vehicle, and vice versa. Accordingly, throughout this description, components, devices, etc., respectively located onboard the first vehicle (e.g., vehicle 102) and the second vehicle (e.g., vehicle 170A-n) may be presented in pairs/counterparts, with the respective functionality available to both components. In an embodiment, the first vehicle and second vehicle can be operating autonomously, semi-autonomously, and suchlike.

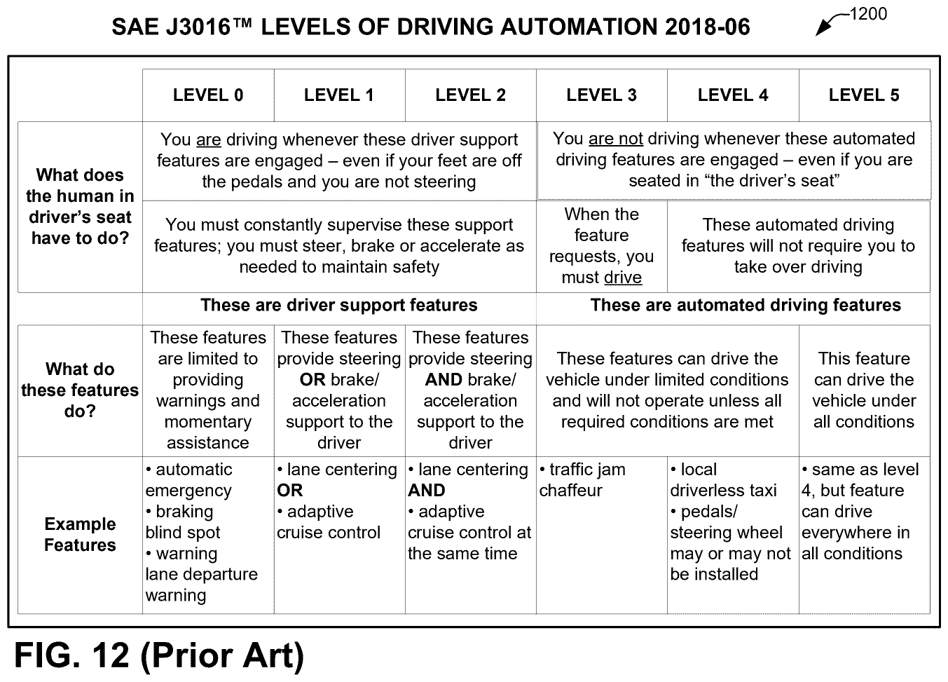

Regarding the phrase “autonomous” operation, to enable the level of sophistication of operation of a vehicle to be defined across the industry by both suppliers and policymakers, standards are available to define the level of autonomous operation. For example, the International Standard J3016 Taxonomy and Definitions for Terms Related to Driving Automation Systems for On-Road Motor Vehicles has been developed by the Society of Automotive Engineers (SAE) and defines six levels of operation of a driving automation system(s) that performs part or all of the dynamic driving task (DDT) on a sustained basis. The six levels of definitions provided in SAE J3016 range from no driving automation (Level 0) to full driving automation (Level 5), in the context of vehicles and their operation on roadways. Levels 0-5 of SAE J3016 are summarized below and further presented in FIG. 12, Table 1200.

Level 0 (No Driving Automation): At Level 0, the vehicle is manually controlled with the automated control system (ACS) having no system capability, the driver provides the DDT regarding steering, braking, acceleration, negotiating traffic, and suchlike. One or more systems may be in place to help the driver, such as an emergency braking system (EBS), but given the EBS technically doesn't drive the vehicle, it does not qualify as automation. The majority of vehicles in current operation are Level 0 automation.

Level 1 (Driver Assistance/Driver Assisted Operation): This is the lowest level of automation. The vehicle features a single automated system for driver assistance, such as steering or acceleration (cruise control) but not both simultaneously. An example of a Level 1 system is adaptive cruise control (ACC), where the vehicle can be maintained at a safe distance behind a lead vehicle (e.g., operating in front of the vehicle operating with Level 1 automation) with the driver performing all other aspects of driving and has full responsibility for monitoring the road and taking over if the assistance system fails to act appropriately.

Level 2 (Partial Driving Automation/Partially Autonomous Operation): The vehicle can (e.g., via an advanced driver assistance system (ADAS)) steer, accelerate, and brake in certain circumstances, however, automation falls short of self-driving as tactical maneuvers such as responding to traffic signals or changing lanes can mainly be controlled by the driver, as does scanning for hazards, with the driver having the ability to take control of the vehicle at any time.

Level 3 (Conditional Driving Automation/Conditionally Autonomous Operation): The vehicle can control numerous aspects of operation (e.g., steering, acceleration, and suchlike), e.g., via monitoring the operational environment, but operation of the vehicle has human override. For example, the autonomous system can prompt a driver to intervene when a scenario is encountered that the onboard system cannot navigate (e.g., with an acceptable level of operational safety), accordingly, the driver must be available to take over operation of the vehicle at any time.

Level 4 (High Driving Automation/High Driving Operation): advancing on from Level 3 operation, while under Level 3 operation the driver must be available, with Level 4, the vehicle can operate without human input or oversight but only under select conditions defined by factors such as road type, geographic area, environments limiting top speed (e.g., urban environments), wherein such limited operation is also known as “geofencing”. Under Level 4 operation, a human (e.g., driver) still has the option to manually override automated operation of the vehicle.

Level 5 (Full Driving Automation/Full Driving Operation): Level 5 vehicles do not require human attention for operation, with operation available on any road and/or any road condition that a human driver can navigate (or even beyond the navigation/driving capabilities of a human). Further, operation under Level 5 is not constrained by the geofencing limitations of operation under Level 4. In an embodiment, Level 5 vehicles may not even have steering wheels or acceleration/brake pedals. In an example of use, a destination is entered for the vehicle (e.g., by a passenger, by a supply manager where the vehicle is a delivery vehicle, and suchlike), wherein the vehicle self-controls navigation and operation of the vehicle to the destination.

To clarify, operations under levels 0-2 can require human interaction at all stages or some stages of a journey by a vehicle to a destination. Operations under levels 3-5 do not require human interaction to navigate the vehicle (except for under level 3 where the driver is required to take control in response to the vehicle not being able to safely navigate a road condition).

As referenced herein, DDT relates to various functions of operating a vehicle.

DDT is concerned with the operational function(s) and tactical function(s) of vehicle operation, but may not be concerned with the strategic function. Operational function is concerned with controlling the vehicle motion, e.g., steering (lateral motion), and braking/acceleration (longitudinal motion). Tactical function (aka, object and event detection and response (OEDR)) relates to the navigational choices made during a journey to achieve the destination regarding detecting and responding to events and/or objects as needed, e.g., overtake vehicle ahead, take the next exit, follow the detour, and suchlike. Strategic function is concerned with the vehicle destination and the best way to get there, e.g., destination and way point planning. Regarding operational function, a Level 1 vehicle under SAE J3016 controls steering or braking/acceleration, while a Level 2 vehicle must control both steering and braking/acceleration. Autonomous operation of vehicles at Levels 3, 4, and 5 under SAE J3016 involves the vehicle having full control of the operational function and the tactical function. Level 2 operation may involve full control of the operational function and tactical function but the driver is available to take control of the tactical function.

Accordingly, the term “autonomous” as used herein regarding operation of a vehicle with or without a human available to assist the vehicle in self-operation during navigation to a destination, can relate to any of Levels 1-5. In an embodiment, for example, the terms “autonomous operation” or “autonomously” can relate to a vehicle operating at least with Level 2 operation, e.g., a minimum level of operation is Level 2: partially autonomous operation, per SAE J3016. Hence, while Level 2, partially autonomous operation, may be a minimum level of operation, higher levels of operation, e.g., Levels 3-5, are encompassed in operation of the vehicle at Level 2 operation. Similarly, a minimum Level 3 operation encompasses Levels 4-5 operation, and minimum Level 4 operation encompasses operation under Level 5 under SAE J3016.

It is to be appreciated that while the various embodiments presented herein are directed towards to one or more vehicles (e.g., vehicle 102) operating in an autonomous manner (e.g., as an autonomous vehicle), the various embodiments presented herein are not so limited and can be implemented with a group of vehicles operating in any of an autonomous manner (e.g., Level 5 of SAE J3016), a partially autonomous manner (e.g., Level 1 of SAE J3016 or higher), or in a non-autonomous manner (e.g., Level 0 of SAE J3016). For example, a first vehicle can be operating in an autonomous manner (e.g., any of Levels 3-5), a partially autonomous manner (e.g., any of levels 1-2), or in a non-autonomous manner (e.g., Level 0), while a second vehicle can also be operating in any of an autonomous manner, a partially autonomous manner, or in a non-autonomous manner.

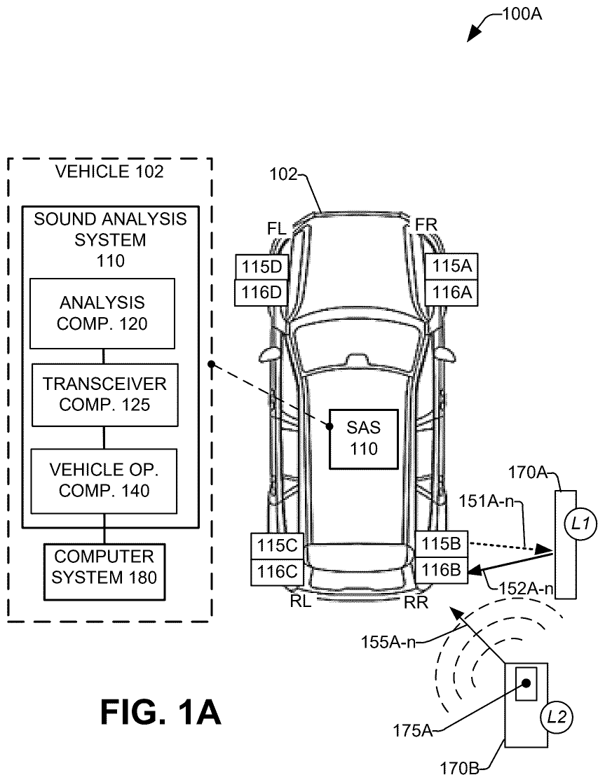

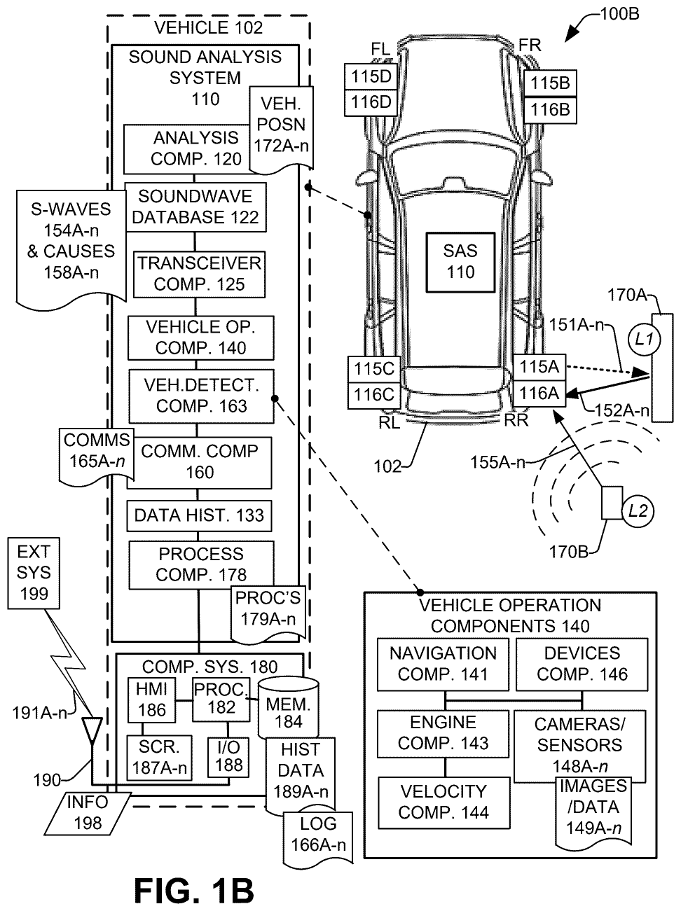

Turning to the figures, FIGS. 1A and 1B, systems 100A and 100B present various configurations for a first vehicle to determine location/motion of a second vehicle, in accordance with an embodiment. FIG. 1A, system 100A, presents a vehicle 102 having located thereon a sound analysis system (SAS) 110. SAS 110 can be configured to transmit, receive, and analyze soundwaves to assist with operation of vehicle 102.

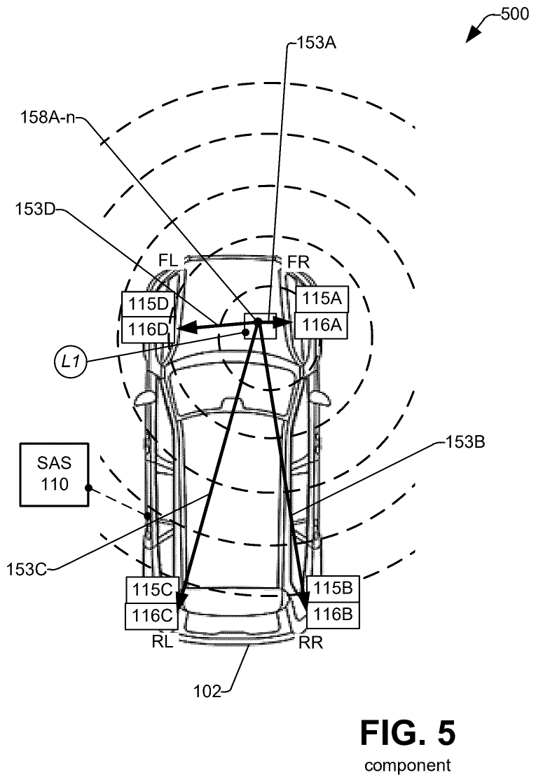

In the following, soundwaves (aka signals, noises) are presented/described with the following identifiers:
a) soundwaves 150A-n is an omnibus term that includes all of the soundwaves 151A-n, 152A-n, 153A-n, 154A-n, 155A-n, and 156A-n, further described in the following (b)-(f).
b) soundwaves 151A-n are soundwaves generated and transmitted by one or more transmitters 115A-n located/operating onboard the first vehicle, vehicle 102.
c) soundwaves 152A-n are reflected soundwaves comprising the one or more soundwaves 150A-n reflected back from a surface, e.g., the surface of vehicle 170A-n (second vehicle), towards one or more receivers 116A-n on the first vehicle 102.
d) soundwaves 153A-n are soundwaves generated and transmitted by a component 158A-n (per FIG. 5) located and/or operating on vehicle 102, whereby component 158A-n can be a worn wheelbearing, an out of balance wheel, and suchlike, as further described. As further described herein, failure of component 158A-n can be determined by comparison of soundwaves 153A-n with previously captured soundwaves 154A-n generated from a known source component 158A-n.
e) soundwaves 155A-n are soundwaves generated and transmitted by one or more transmitters 175A-n located/operating onboard a second vehicle, vehicle 170A-n. In an embodiment, transmitter 175A-n can be configured to generate and transmit a soundwave 155A-n having an audible or inaudible frequency, as previously mentioned.
f) soundwaves 156A-n are soundwaves generated and transmitted by one or more transmitters 175A-n located/operating onboard the second vehicle, vehicle 170A-n. In an embodiment, transmitter 175A-n can be a siren transmitting a soundwave 156A having an audible frequency.

Per the various embodiments presented herein, soundwaves 150A-n can be such that one or more portions of a soundwave can be captured at the series of receivers 116A-n. For example, a first soundwave 151A can be received at receivers 116A-n to enable signal processing/triangulation to be performed, and if pulsed transmission is being utilized, a sound soundwave 151B can be received at receivers 116A-n to enable signal processing/triangulation to be performed at a subsequent moment. Further, soundwaves 150A-n, etc., can comprise a digital waveform, an analog waveform, and suchlike.

As mentioned, depending upon the source/generation of soundwaves 150A-n, soundwaves 150A-n can be comprised entirely of a frequency audible to the human ear, entirely of a frequency inaudible to the human ear, or a combination of both frequencies. For example, where soundwaves 151A-n and 155A-n are audibly generated by transmitters 115A-n/175A-n, soundwaves 150A-n can have a frequency range of 20 Hertz (Hz) to 20 kHz. However, soundwaves 150A-n can also be inaudible to the human ear, having a low frequency (e.g., <20 Hz) and/or a high frequency (e.g., >20 kHz). Utilizing soundwaves 150A-n having an inaudible frequency can prevent annoyance to a person(s) onboard (e.g., driver, passenger, and suchlike) vehicle 102, as well as a person(s) in vicinity of vehicle 102 (e.g., a pedestrian, cyclist, and suchlike). Similarly, where the soundwaves 155A-n are generated by transmitters 175A-n located onboard a second vehicle 170B, wherein the transmitters 175A-n are comparable in operation to transmitters 115A-n, the soundwaves 155A-n can also have a frequency range outside the range of human hearing, to prevent annoyance to a person(s) onboard (e.g., driver, passenger, and suchlike) vehicles 102/170A-n, as well as a person(s) in vicinity of vehicle 170A-n (e.g., a pedestrian, cyclist, and suchlike).

SAS 110 can include an analysis component 120, configured to analyze/control generation of the various soundwaves 150A-n received at vehicle 102, as further described. In an embodiment, analysis component 120 can be configured to analyze/process soundwaves 152A-n reflected from another vehicle 170A-n. In a further embodiment, analysis component 120 can be configured to analyze/process soundwaves 155A-n and 156A-n generated by, and received from, another vehicle 170A-n. In another embodiment, analysis component 120 can be configured to analyze/process soundwaves 153A-n generated by a device/component 158A-n located onboard vehicle 102. As further described, analysis component 120 can be configured to implement artificial intelligence and machine learning (AI & ML) technologies and techniques (e.g., per process component 178 and processes 179A-n) to determine location/operational state of vehicle 170A-n and/or component 158A-n.

As mentioned, in an embodiment, soundwaves 151A-n can be generated and transmitted from one or more transmitters 115A-n (e.g., set of, group of, collection of, multiple transmitters) located on vehicle 102. Any suitable device/component can be utilized as a transmitter 115A-n, e.g., a speaker, noise emitter, siren, etc. It is to be appreciated that while FIG. 1A illustrates four transmitters 115A-D being utilized on vehicle 102, any number of transmitters 115A-n can be utilized, e.g., to ensure a desired level of monitoring/detection, such as 360° coverage/generation/detection of soundwaves 151A-n around vehicle 102.

Further, one or more receivers 116A-n (e.g., set of, group of, collection of, multiple receivers) can be located/operating onboard vehicle 102. Receivers 116A-n can be configured to receive and process soundwaves 150A-n across the audible and/or inaudible frequency ranges. Any suitable device/component can be utilized as a receiver 116A-n, e.g., a microphone or other signal/sound capturing device. Hence, where a soundwave 156A-n is an audible siren, e.g., generated by a second vehicle 170, where second vehicle 170 is an emergency vehicle, the audible soundwaves 156A-n can be processed by receivers 116A-n, with subsequent analysis by a transceiver component 125 (e.g., wave-processing). It is to be appreciated that while FIG. 1A illustrates four receivers 116A-D being utilized on vehicle 102, any number of receivers 116A-n can be utilized, e.g., to ensure 360°coverage/detection of soundwaves 150A-n around vehicle 102.

SAS 110 can further include a transceiver component 125, wherein the transceiver component 125 can be configured to control operation of the respective transmitters 115A-n, e.g., regarding frequency, wavelength, amplitude, waveform, signal pulsing, timing, timestamp, direction, signal strength, phase, and suchlike, of soundwaves 150A-n. Transceiver component 125 can be further configured to control operation of the respective receivers 116A-n. Transceiver component 125 can operate in conjunction with analysis component 120 to enable determination of location L₁₋ₙ, motion, etc., of vehicle 170A, whereby analysis component 120 can utilize operational information (e.g., in communications 165A-n), such as signal strength data, triangulation data, and suchlike, and further control operation of the transceiver component 125 regarding transmission/reception of soundwaves 150A-n.

In the various examples presented herein, transmitter 115A and receiver 116A are located at the front-right (FR) of vehicle 102, transmitter 115B and receiver 116B are located at the rear-right (RR), transmitter 115C and receiver 116C are located at the rear-left (RL), and transmitter 115D and receiver 116D are located at the front-left (FL) of vehicle 102. However, any number of transmitters 115A-n and receivers 116A-n can be utilized, and located around vehicle 102. As further mentioned, relative location of a soundwave 150A-n being received at vehicle 102 can be determined/inferred relative to signal strength and suchlike at each of the receivers 116A-n, e.g., energy of soundwave 150A-n is strongest at the RL of vehicle 102.

As mentioned, in another embodiment of operation, one or more of the receivers 116A-n can detect a soundwave 150A-n being generated by a second vehicle 170A-n, wherein the second vehicle 170A-n can be adjacent/proximate (e.g., at a position L₁) to the first vehicle, vehicle 102. For example, vehicle 102 may be operating on a road/lane which the second vehicle 170A is looking to access (e.g., the road is a highway and second vehicle 170A is attempting to merge onto the highway, the second vehicle 170A is attempting to merge into a lane of the highway in which vehicle 102 is operating). A soundwave 155A-n generated by a transmitter 175A-n located onboard the second vehicle 170A-n can be detected by one or more receivers in the set of receivers 116A-n located onboard the first vehicle 102, whereby the location/motion of the second vehicle 170A-n can be determined/inferred. With repeated/continuous transmission of soundwaves 155A-n, the first vehicle 102 can determine a change in location/motion of the second vehicle 170A-n. If required, vehicle 102 can further maneuver to avoid obstructing progress of the emergency vehicle 170A, whereby the analysis component 120 can operate in conjunction with one or more of the vehicle operation components 140 to enable maneuvering of vehicle 102 in accordance with location/motion of the second vehicle 170A-n.

In another embodiment, the second vehicle 170A can be an emergency vehicle, with the siren soundwave 156A-n being captured by the set of receivers 116A-n, whereby the soundwave 156A-n received by the respective receivers in the set of receivers 116A-n can be analyzed (e.g., triangulated) to enable location/motion of the emergency vehicle 170A, relative to vehicle 102, to be determined, and if required, vehicle 102 can further maneuver to avoid obstructing progress of the emergency vehicle 170A. Repeated/continued transmission of the siren soundwave 156A-n enables the location/motion of the emergency vehicle 170A to be determined by vehicle 102.

In a further embodiment, the soundwaves 153A-n can be generated by a component 158A-n (e.g., undergoing initial failure) located onboard vehicle 102, wherein the soundwaves 153A-n can be captured by one or more of receivers 116A-n and further analyzed by analysis component 120 to determine the source/cause (e.g., component 158A-n) of the soundwaves 153A-n and operational condition of the source.

It is to be appreciated that while the various embodiments and example scenarios pertain to detection of a vehicle 170A-n, the various embodiments are not so limited and can be applied to any object/entity proximate to vehicle 102, where such object/entity can be a pedestrian, a person running, a cyclist, an animal, and suchlike.

As further shown, SAS 110 can be communicatively coupled to a computer system 180. In an embodiment, computer system 180 can be a vehicle control unit (VCU) configured to control operation of vehicle 102. In an embodiment, computer system 180 can be configured to operate/control/monitor various vehicle operations (e.g., when being operated autonomously, semi-autonomously, and the like), wherein the various operations can be controlled by one or more vehicle operation components 140 communicatively coupled to the computer system 180, as further described per FIG. 1B.

Turning to FIG. 1B, system 100B provides further detail regarding the sound analysis system 110 and operation presented in FIG. 1A, in accordance with one or more embodiments.

As previously mentioned, transmitters 115A-n and receivers 116A-n can be utilized to assist in operation of vehicle 102, whereby soundwaves 150A-n can be received at the receivers 116A-n, and further processed to determine a location of a vehicle 170A-n proximate to vehicle 102.

As previously mentioned, vehicle 102 can include various vehicle operation components 140. The vehicle operation components 140 can include a navigation component 141 configured to navigate vehicle 102 along a route. In an embodiment, the navigation component 141 can operate in conjunction with analysis component 120, such that, in the event of a determination by the analysis component 120 that a second vehicle 170A-n is proximate to/approaching vehicle 102, the analysis component 120 can provide navigation component 141 with determined information (e.g., in communications 165A-n), e.g., vehicle position information 172A-n (e.g., location L), regarding operation of vehicle 170A-n relative to vehicle 102, enabling navigation component 141 to adjust operation of vehicle 102 to avoid/not impede vehicle 170A-n. For example, navigation 141 can cause vehicle 102 to accelerate, reduce velocity, stop, pullover to the side of the road, change lane, and suchlike. The navigation component 141 can be further configured to, e.g., in conjunction with velocity component 144, to determine a current motion (e.g., velocity) of vehicle 102. In an embodiment, with navigation component 141 having knowledge of a position of vehicle 102, even while in motion, it is possible for analysis component 120 and/or the navigation component 141 to determine location L (moving or stationary) of vehicle 170A-n relative to vehicle 102.

The vehicle operation components 140 can further include an engine component 143 configured to control operation, e.g., start/stop, of an engine configured to propel the vehicle 102.

As mentioned, the vehicle operation components 140 can further comprise a velocity component 144 configured to control motion of the vehicle 102, e.g., maintain velocity, accelerate, slow down, brake, stop, etc. The velocity component 144 can also be configured to control acceleration/deceleration of the vehicle 102 (e.g., to enable vehicle 170A-n to merge, change lane, etc.), wherein acceleration, braking, etc., of the vehicle 102 can form part of the DDT operational function, as previously described. Operation of velocity component 144 can be based on operation information/instruction in a communication 165A-n, e.g., generated by analysis component 120, per soundwaves 150A-n received at receivers 116A-n/processed by transceiver component 125, and/or navigation component 141. Velocity component 144 and navigation component 141 can utilize signals generated by various sensors (not shown) configured to monitor motion, direction, velocity, and suchlike, of vehicle 102.

Vehicle operation components 140 can further include a devices component 146, wherein the devices component 146 can be configured to control operation of various devices located on vehicle 102. The various devices can include devices to create a visual signal/alarm (e.g., headlights, hazard lights, and suchlike), and also devices to create an audible signal/alarm (e.g., car horn; an audible device such as a speaker configured to transmit and generate audible signals such as “warning, vehicle nearby”, and suchlike).

The vehicle operation components 140 can further comprise various cameras and/or sensors 148A-n configured to monitor operation of vehicle 102 and further obtain imagery and other information 149A-n regarding an environment/surroundings in which vehicle 102 is operating. The cameras/sensors 148A-n can include any suitable detection/measuring device, including cameras, optical sensors, laser sensors, Light Detection and Ranging (LiDAR) sensors, sonar sensors, audiovisual sensors, perception sensors, distance sensors, road lane sensors, motion detectors, velocity sensors, and the like, as employed in such applications as simultaneous localization and mapping (SLAM), and other computer-based technologies and methods utilized to determine an environment being navigated by vehicle 102, location of the vehicle 102 within the environment (e.g., location mapping), presence and operation of other vehicles (e.g., vehicles 170A-n), distance between vehicles, braking distance, and suchlike. In an embodiment, images/data 149A-n captured by the cameras and/or sensors 148A-n can be utilized to supplement/confirm data 165A-n generated by analysis component 120. For example, in response to a determination by analysis component 120 that soundwaves 150A-n indicate a vehicle 170A is approaching vehicle 102, the cameras and/or sensors 148A-n can be utilized to confirm that a vehicle 170A is indeed approaching (and further location, motion, velocity, etc.) relative to vehicle 102. In response to a determination that no vehicle 170A is approaching 102, even though soundwaves 150A-n appear to indicate otherwise, processes 179A-n can be updated/trained/fine-tuned to prevent a future erroneous interpretation of soundwaves 150A-n.

In an embodiment, cameras/sensors 148A-n can be configured to capture and/or generate images/data 149A-n, e.g., visual images/information/data (e.g., based on light reflection/capture) from the environment/surroundings in a respective field of view of cameras/sensors 148A-n, as well as also being respectively configured to generate data, etc., based upon transmission and reflection of a signal (e.g., an infra-red (IR) signal). Images/data 149A-n, and the like generated by cameras/sensors 148A-n can be analyzed by processes 179A-n (aka, functions, operations, algorithms, etc.) to identify respective features of interest such as presence, distance to, motion of another vehicle (e.g., vehicles 170A-n). Further, the cameras/sensors 148A-n can be controlled by any of the respective components located onboard vehicle 102. For example, a vehicle detection component 163 can control operation (e.g., on/off, direction/field of view, etc.) of the cameras/sensors 148A-n to enable detection of a vehicle (e.g., vehicle 170A-n).

As mentioned, SAS 110 can further include a vehicle detection component 163, wherein the vehicle detection component 163 can be configured to, in a non-limiting list, detect presence, location L, motion, operation, direction, and/or communicate with another vehicles (e.g., vehicle 170A-n) also navigating the road being navigated by the vehicle 102. The vehicle detection component 163 can be configured to receive information regarding vehicle 170A-n in data 149A-n generated by the cameras/sensors 148A-n, a direction to a vehicle 170A-n, e.g., in a communication 165A-n generated by analysis component 120.

SAS 110 can further include a soundwave database 122, wherein the soundwave database 122 is a database comprising a library/set of known/previously captured/analyzed soundwaves 154A-n in conjunction with the respective source 158A-n (e.g., component, device, and suchlike) of the known soundwaves 154A-n. Soundwave database 122 can be included in memory 184. For example, a source 158A can be a wheelbearing having a distinctive soundwave 154A, whereby the soundwave 154A may alter based on whether the wheelbearing is in an initial or advanced state of failure. Another source 158B can be a wheel being out of alignment and gives rise to a distinctive soundwave 154B. The number of known soundwaves 154A-n and sources/causes 158A-n can be myriad. During operation of vehicle 102, respective soundwaves 153A-n generated by the respective components 158A-n can be captured by the various receivers 116A-n and stored in the soundwave database 122. Analysis component 120 (e.g., in conjunction with process component 178/processes 179A-n) can be configured to compare a soundwave 153A-n with the known soundwaves 154A-n in soundwave database 122. In the event of analysis component 120 matching a prior soundwave 154A-n with a current/unknown soundwave 153A-n, the cause 158A-n of the soundwave 153A-n can be identified, with a notification communication 165A-n generated. The notification communication 165A-n can be presented/distributed as required, e.g., (a) be presented to an operator (e.g., driver, passenger, and suchlike) of vehicle 102 (e.g., via HMI 186/screens 187A-n), (b) placed in a vehicle operation log 166A-n for review during servicing/repair of vehicle 102, (c) transmitted to an external entity 199 (e.g., a service center, a manufacturer's central system monitoring operation/gathering data regarding their vehicles, and suchlike), etc.

It is to be appreciated that while the term “communication” is presented herein with regard to communications 165A-n, the content of a communication 165A-n can include a notification, data, information, instruction, request, response, warning, and suchlike, and further the communications 165A-n can be generated, transmitted, and/or received by any of the components (e.g., in SAS 110) located and operating onboard vehicle 102, and between any vehicle 102 and vehicles 170A-n. The respective components are configured to analyze, generate, act upon, transmit, and receive information/data/communications 165A-n between the components (e.g., SAS 110 and subcomponents), and further, to other vehicles 170A-n, and suchlike.

SAS 110 can also include a data historian 133 configured to generate/update historical data 189A-n with any information regarding current/prior soundwaves 150A-n, locations L1-n of vehicle 102 and/or vehicles 170A-n, soundwaves 154A-n, causes 158A-n, vehicle positions 172A-n, entries in operation log 166A-n, images/data 149A-n, similarity indexes S₁₋ₙ, vectors Vn, and suchlike. Historical data 189A-n can be utilized by a process component 178/one or more AI/ML processes 179A-n, etc., to determine location of vehicle 170A-n and according operation of vehicle 102.

As shown in FIG. 1B, computer system 180 can be communicatively coupled to/included in the SAS 110. Computer system 180 can include a memory 184 that stores the respective computer executable components (e.g., analysis component 120, transceiver component 125, vehicle operation component(s) 140, navigation component 141, engine component 143, velocity component 144, devices component 146, vehicle detection component 163, communication component 160, process component 178, and suchlike), and further, a processor 182 configured to execute the computer executable components stored in the memory 184. Memory 184 can be further configured to store/include soundwaves 150A-n, 151A-n, 152A-n, 153A-n, 155A-n, 156A-n, prior recorded soundwaves 154A-n, sources/causes 158A-n, communications 165A-n, processes 179A-n, locations L₁₋ₙ of vehicles 102 and 170A-n, images/data 149A-n, operation log 166A-n, and further, historical data 189A-n, wherein historical data 189A-n can include any previously/current/future defined/identified/processed signals 154A-n, sources/causes 158A-n, soundwaves 150A-n, vectors V₁₋ₙ, similarity indexes S₁₋ₙ, and suchlike.

In an embodiment, the vehicle operation components 140 can comprise standalone components communicatively coupled to the computer system 180, and while not shown, the vehicle operation components 140 can operate in conjunction with a processor (e.g., functionally comparable to processor 182) and a memory (e.g., functionally comparable to memory 184) to enable navigation, steering, braking/acceleration, etc., of vehicle 102 to a destination. In another embodiment, the vehicle operation components 140 can operate in conjunction with the processor 182 and memory 184 of the computer system 180, wherein the various control functions (e.g., navigation, steering, braking/acceleration) can be controlled by the computer system 180.

Similarly, SAS 110 can form a standalone component communicatively coupled to the computer system 180, and while not shown, SAS 110 can operate in conjunction with a processor (e.g., functionally comparable to processor 182) and a memory (e.g., functionally comparable to memory 184) to enable safe operation when another vehicle 170A-n is detected proximate to/approaching vehicle 102. In another embodiment, the SAS 110 can operate in conjunction with the processor 182 and memory 184 of the computer system 180, wherein the various aspects of processing and utilizing soundwaves 150A-n can be controlled by the computer system 180. In a further embodiment, the computer system 180, vehicle operation components 140, and the SAS 110 (and respective sub-components) can operate using a common processor (e.g., processor 182) and memory (e.g., memory 184).

The computer system 180 can further include a human machine interface (HMI) 186 (e.g., a display, a graphical-user interface (GUI), infotainment system) which can be configured to present various information regarding any of soundwaves 150A-n, 151A-n, 152A-n, 153A-n, 155A-n, 156A-n, prior recorded soundwaves 154A-n, sources/causes 158A-n, communications 165A-n, processes 179A-n, images/data 149A-n, operation log 166A-n, and further, historical data 189A-n, etc., per the various embodiments presented herein. HMI 186 can include an interactive display 187A-n to present the various information via various screens presented thereon, and further configured to facilitate input of information/settings/selections, etc., regarding operation of the vehicle 102. In an embodiment, in the event that vehicle 102 is being operated in an autonomous manner (e.g., Level 5 of SAE J3016), notification communications 165A-n can be utilized to present a warning on the HMI 186 and screen 187A-n to notify a passenger of vehicle 102 of the proximity of vehicle 170A-n, issue with component 158A-n, and suchlike.

As further shown, the computer system 180 can include an input/output (I/O) component 188, wherein the I/O component 188 can be a transceiver configured/communicatively coupled to enable transmission/receipt (via antenna 190) of signals 191A-n, position information L₁₋ₙ, communications 165A-n, and suchlike, between the SAS 110/navigation component 141/computer system 180 and any external system(s), including vehicle 170A-n. Any suitable technology can be utilized to enable the various embodiments presented herein, regarding transmission and receiving of signals 191A-n. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

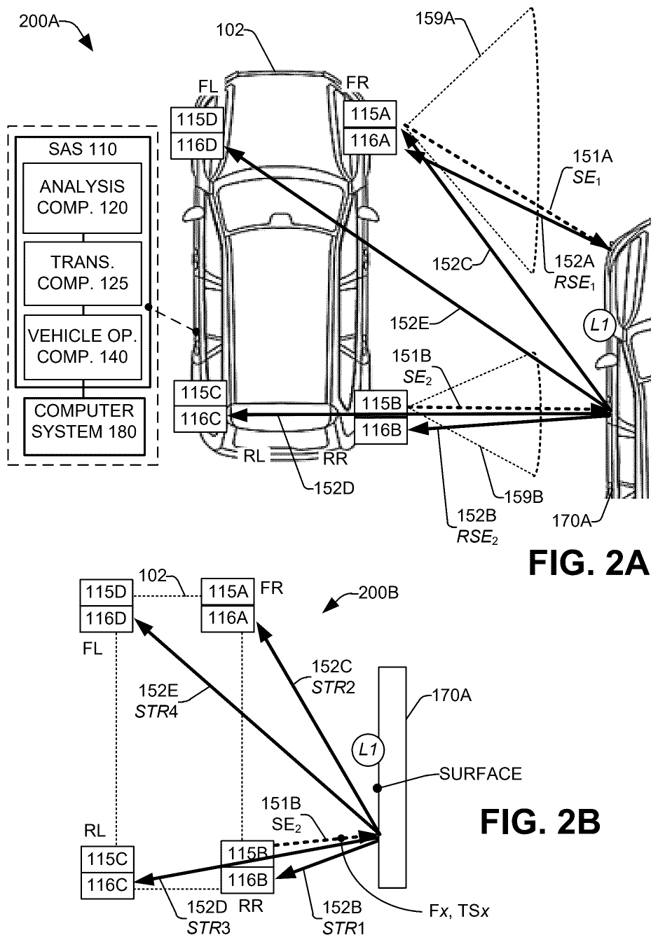

FIGS. 2A and 2B presents schematics 200A-B illustrate implementation of soundwaves by a first vehicle to determine proximity of a second vehicle, in accordance with an embodiment.

As shown, respective transmitters 115A-n are configured to transmit respective soundwaves 150A-n, whereby the soundwaves 150A-n can be being transmitted with respective arcs of transmission 159A-n. Generation and transmission of soundwaves 150A-n by the transmitters 115A-n can be controlled by transceiver component 125.

As shown, a vehicle 170A is proximate to the vehicle 102, e.g., vehicle 170A is navigating (e.g., merging) into a lane of a road in which vehicle 102 is driving. As further shown, a first soundwave 151A is being transmitted by first transmitter 115A while a second soundwave 151B is being transmitted by second transmitter 115B. As shown, owing to the position of vehicle 170A, a portion of first soundwave 151A is reflected in first reflected soundwave 152A from vehicle 170A towards first receiver 116A, and a portion of second soundwave 151B is reflected in second reflected soundwave 152B from vehicle 170A towards second receiver 116B. In an example scenario of operation, owing to the position of vehicle 170A, the relative magnitude of first soundwave 151A and first reflected soundwave 152A is less than the relative magnitude of second soundwave 151B and second reflected soundwave 152B. For example, a greater portion of total sound energy in the second soundwave 151B is reflected back (to receiver 116B) in the second reflected soundwave 152B than the portion of total sound energy in the first soundwave 151A reflected back (to receiver 116A) in the first reflected soundwave 152A. Hence, in an embodiment where the total sound energy (e.g., SE₁) transmitted in the first soundwave 151A is the same as the total sound energy (e.g., SE₂) transmitted in the second soundwave 151B, such that SE₁=SE₂, and first reflected sound energy (e.g., RSE₁) in first reflected soundwave 152A is less than the second reflected sound energy (e.g., RSE₂) in second reflected soundwave 152B, such that RSE₁<RSE₂, analysis component 120 can be configured to determine that (a) given a reflected soundwave 152A and/or 152B, a vehicle 170A is determined/detected to be present proximate to vehicle 102, and further (b) given that, where SE₁=SE₂, and RSE₁<RSE₂, vehicle 170A is determined, by analysis component 120, to be closer to receiver 116B than receiver 116A.

In an embodiment, respective soundwaves 151A-n can be generated with different frequencies, thereby enabling determination (e.g., by transceiver component 125 and/or analysis component 120) of which transmitter 115A-n generated a respective soundwave 151A-n. Hence, first soundwave 151A was transmitted with a first frequency F₁ by first transmitter 115A, while second soundwave 151B was transmitted with a second frequency F₂ by second transmitter 115B, wherein frequencies F₁ and F₂ are disparate. Reflected soundwaves 152A-n can have the frequency of the transmitted soundwave 152A-n that was reflected to form the respective reflected soundwave 152A-n, e.g., reflected soundwave 152A generated from transmitted soundwave 151A has a frequency F₁, while reflected soundwave 152B generated from transmitted soundwave 151B has a frequency F₂. Similar to utilizing different frequencies F₁₋ₙ, soundwaves 151A-n can also be generated with different wavelengths, amplitudes, phase, pulsed generation, and suchlike, to facilitate differentiation of respective soundwaves (e.g., reflected soundwaves 152A-n) generated based on initial soundwaves 151A-n.

Further, a respective transmitted soundwave 151A-n can also have a timestamp TS₁₋ₙ (aka time signature) associated therewith, such that rather than soundwaves 151A-n being continually generated and transmitted, soundwaves 151A-n can be generated and transmitted in a sequenced/pulsed wave fashion. Hence, an initial soundwave 151X generated/transmitted by a transmitter 115B, having a frequency Fₓ at time TSₓ can be subsequently followed by a subsequent soundwave 151X+1 generated/transmitted by a transmitter 115B, having a frequency F_{y} at time TSₓ₊₁.

Accordingly, the respective reflected soundwaves 152A-n received at any of receivers 116A-n and/or a specific receiver (e.g., receiver 116B) can have different timestamps TS₁₋ₙ and, and also, different/unique frequencies F₁₋ₙ. By knowing any of the respective frequency F₁₋ₙ, timestamp TS₁₋ₙ, and/or energy, analysis component 120 can be configured to determine which transmitter 115A-n generated the transmitted soundwave 151A-n from which a reflected soundwave 152A-n is generated, and further a moment in time at which the initial soundwave 151A-n was generated (e.g., enabling a distance to target vehicle 170A-n/distance to receiver 116A-n time-of-flight to be determined). It is to be appreciated that any suitable technology to enable separation of respective reflected soundwaves 152A-n, time of transmission of soundwaves 152A-n, and suchlike, can be utilized in accordance with the various embodiments presented herein to enable analysis component 120 to utilize respective transmitted soundwaves 151A-n and reflected soundwaves 152A-n to determine (e.g., triangulate) a presence, location, distance, motion, etc., of vehicle 170A-n relative to vehicle 102.

Further extending analysis that can be performed by analysis component 120, transmitted soundwave 151B is transmitted by transmitter 115B, reflected from vehicle 170A, with reflected soundwaves 152B-n generated and captured by receivers 116A-n. For example, reflected soundwave 152B (having a signal strength STR₁) is received at receiver 116B, reflected soundwave 152C (having a signal strength STR₂) is received at receiver 116A, reflected soundwave 152D (having a signal strength STR₃) is received at receiver 116C, reflected soundwave 152E (having a signal strength STR₄) is received at receiver 116D. Per the foregoing regarding respective frequencies F₁₋ₙ, signal strengths STR₁₋ₙ, timestamps TS₁₋ₙ, location of receiver 116A-n on vehicle 102, analysis component 120 can determine location of vehicle 170A relative to vehicle 102. Per FIGS. 2A and 2B, in an example order of sequence of receiving reflected soundwaves 152B-n generated from initial soundwave 151B, is it likely that: first=reflected soundwave 152B is received at receiver 116B, second=reflected soundwave 152C received at receiver 116A, third=reflected soundwave 152D received at receiver 116C, and fourth=reflected soundwave 152E received at receiver 116D, wherein STR₁>STR₂>STR₃>STR₄.

Accordingly, based on the foregoing, analysis component 120 can be configured to determine that vehicle 170A is off to the rear right (RR) of vehicle 102.

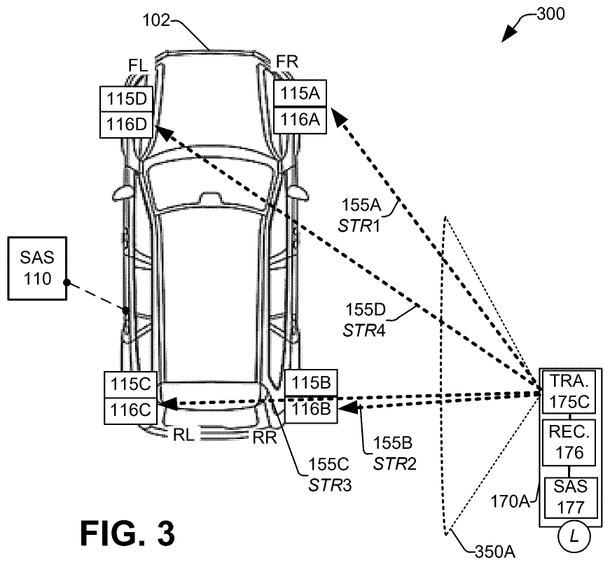

FIG. 3 presents a schematic 300 illustrating implementation of soundwaves received at a first vehicle to determine proximity of a second vehicle, in accordance with an embodiment.

In an embodiment, similar to operation of a first vehicle 102 with regard to transmission of soundwaves 150A-n to determine a presence of a second vehicle 170A, second vehicle 170A can also be equipped/configured to transmit soundwaves, e.g., soundwaves 155A-n (in soundwave transmission arc 350A), to detect the presence of another vehicle. For example, vehicle 170A can be configured with a set of transmitters 175A-n (and receivers 176A-n). Furthermore, vehicle 170A can be configured with a SAS 177, wherein SAS 177 is comparable to SAS 110, and included components.

In an embodiment, receivers 116A-n on vehicle 102 can be configured to receive the soundwaves 155A-n, wherein, respective wave portions 155A, 155B, 155C, and 155D can be received/captured by receivers 116A-n. As previously mentioned (e.g., per FIGS. 2A and 2B), the different magnitudes of signal strength STR₁₋ₙ in respective wave portions 155A-n can be utilized to triangulate a location L of vehicle 170A. E.g., a first soundwave 155A is received at first receiver 116A with a first signal strength STR₁, a second soundwave 155B is received at second receiver 116B with a second signal strength STR₂, a third soundwave 155C is received at third receiver 116C with a third signal strength STR₃, and a fourth soundwave 155D is received at fourth receiver 116D with a fourth energy magnitude STR₄. Hence, as depicted in FIG. 3, in order of magnitude, STR₂>STR₁>STR₃>STR₄, and, accordingly, analysis component 120 determines from the soundwave portions 155A-n that location L of vehicle 170 is to the rear right (RR) of vehicle 102.

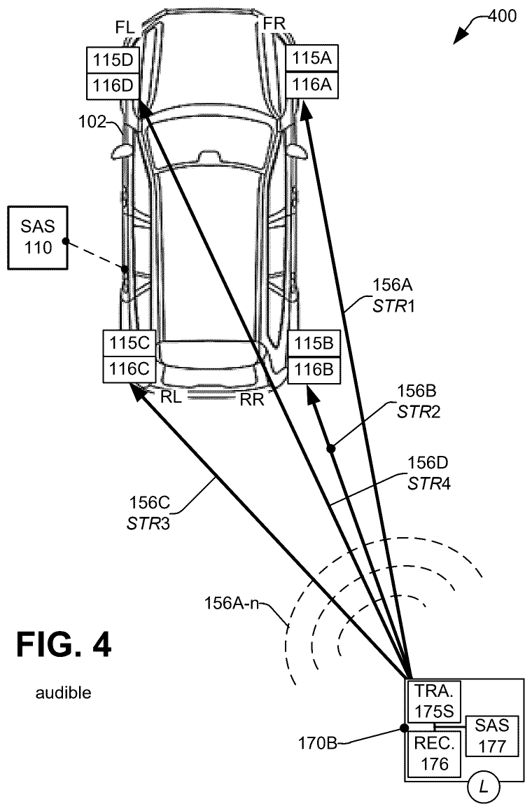

FIG. 4 presents a schematic 400 illustrating implementation of soundwaves received at a first vehicle to determine proximity of a second vehicle, in accordance with an embodiment.

FIG. 4 presents a similar operating scenario to that depicted in FIG. 3, however, soundwaves 156A-n (and respective wave portions) can be generated by/received from an audible siren 175S located/operating on vehicle 170B, wherein vehicle 170B can be a vehicle equipped with a siren 175S, such as an emergency vehicle (e.g., an ambulance, a fire engine, a police car, police motorbike, and suchlike).

In an embodiment, similar to operation of a first vehicle 102 with regard to transmission of soundwaves 151A-n to determine a presence of a second vehicle 170A, second vehicle 170A can also be equipped/configured to transmit soundwaves from a siren 175S, to enable vehicle 102 to detect the presence of vehicle 170B. Furthermore, vehicle 170B can be configured with a SAS 177, wherein SAS 177 is comparable to SAS 110, and included components.

In an embodiment, receivers 116A-n on vehicle 102 can be configured to receive the soundwaves 156A-n. As previously mentioned, the different signal strengths of sound energy STR₁₋ₙ in respective wave portions 156A-n can be utilized to triangulate a location L of vehicle 170A. E.g., a first soundwave 156A received at first receiver 116A has a first signal strength STR₁, a second soundwave 156B received at second receiver 116B has a second signal strength STR₂, a third soundwave 156C received at third receiver 116C has a third signal strength STR₃, and a fourth soundwave 156D received at fourth receiver 116D has a fourth signal strength STR₄. Hence, as depicted in FIG. 4, in order of magnitude, STR₂>STR₁>STR₃>STR₄, and, accordingly, analysis component 120 determines from the soundwaves 156A-n (and respective portions) that vehicle 170 is located at the rear right, RR, of vehicle 102.

FIG. 5 presents a schematic 500 illustrating capturing soundwaves by an onboard system to enable determination of a component/device potentially undergoing failure, in accordance with an embodiment.

As shown in FIG. 5, operation of a component 158A-n onboard vehicle 102 is generating/producing soundwaves 153A-n, whereby soundwaves 153A-n are emanating from the component 158A-n. Soundwaves 153A-n can be respectively captured by the respective receivers 116A-n also located onboard vehicle 102. In an embodiment, the soundwaves 153A-n can comprise an audible frequency, an inaudible frequency, or combination thereof (e.g., a first audible portion and a second inaudible portion). Accordingly, while component 158A-n may be undergoing an operational issue, the issue may not be discernable to the human ear, but analysis component 120 can be configured to analyze any inaudible soundwaves 153A-n (or portions thereof) to enable identification of the operational issue prior to audible soundwaves 153A-n being produced.

As previously mentioned, the analysis component 120 (in conjunction with process component 178 and processes 179A-n) can be configured to compare the soundwaves 153A-n with known soundwaves 154A-n and causes/sources 158A-n in soundwave database 122, to facilitate analysis and potential matching/identification between soundwaves 153A-n and the known soundwaves 154A-n to enable the source 158A-n of the soundwaves 153A-n to be identified. Identification, by analysis component 120, of a source component 158A-n can be based on any suitable technique, e.g., comparison of waveforms, frequencies, waveform during respective operation of vehicle 102 (e.g., while accelerating, braking, constant velocity, and suchlike), etc., between known soundwaves 154A-n and received soundwaves 153A-n.

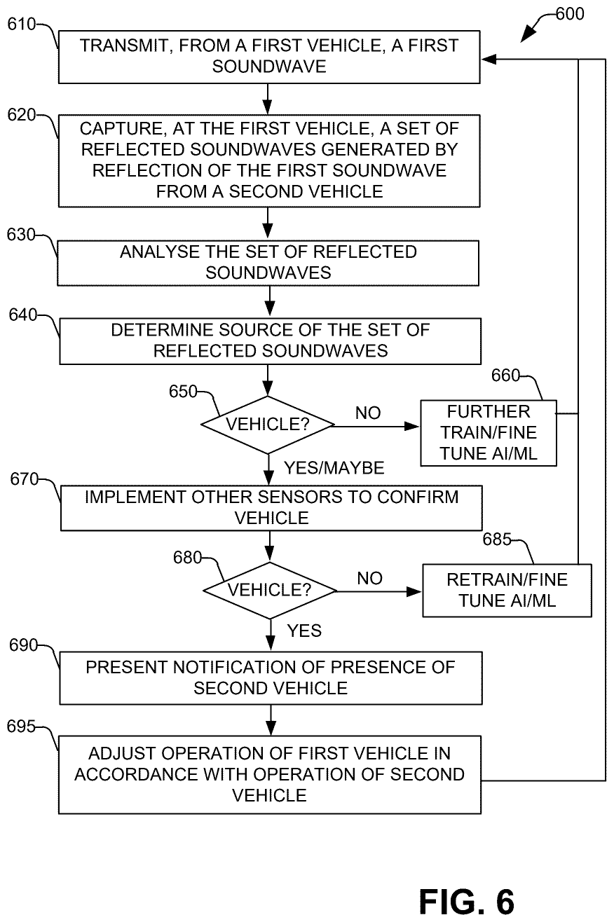

FIG. 6 illustrates a flow diagram 600 for a computer-implemented method for utilizing soundwaves to determine a position of a vehicle, in accordance with at least one embodiment.

At 610, one or more soundwaves (e.g., soundwave 151A-n) can be generated and transmitted (e.g., by one or more transmitters 115A-n controlled by transceiver 125), wherein the soundwave can be transmitted from a first vehicle (e.g., vehicle 102). As previously mentioned, the soundwaves can be generated and transmitted with different frequencies, wavelengths, amplitudes, phase, pulsing, time stamps, and suchlike.

At 620, one or more reflected soundwaves (e.g., reflected soundwaves 152A-n) can be received and captured (e.g., by one or more receivers 116A-n controlled by transceiver 125), wherein the reflected soundwaves can be received as a function of the transmitted soundwaves (e.g., soundwaves 151A-n) being reflected from a surface of a second vehicle (e.g., vehicle 170A) operating/located in proximity to the first vehicle.

At 630, an analysis component (e.g., analysis component 120) can be configured to analyze the one or more reflected soundwaves. As previously mentioned, the initial soundwaves (e.g., soundwaves 151A-n) can be generated with disparate frequencies, amplitudes, wavelengths, phase, pulsing, etc., whereby the analysis component can be configured to distinguish the respective reflected soundwaves regarding location of transceiver receiving the respective soundwave, and suchlike.

At 640, the analysis component can be further configured to determine/identify the source (e.g., vehicle 170A) of the reflected soundwaves, where, as previously mentioned, any suitable technique/technology can be utilized to determine a source of the soundwaves, e.g., triangulation, signal strength analysis, and suchlike.

At 650, the analysis component can determine whether the source of the soundwaves are from a vehicle or not. In response to a determination, by the analysis component, that NO, the soundwaves are not sourced (e.g., reflected from) a second vehicle, method 600 can advance to step 660, whereupon the processes (e.g., process component 178 and processes 179A-n) utilized by the analysis component can be further trained with the soundwaves and determined source, to improve the ability of the respective processes to correctly identify a vehicle (and location, motion, etc.). Method 600 can return to step 610 for subsequent transmission and processing of further soundwaves (e.g., soundwaves 150A-n).

At 650, in response to a determination, by the analysis component, that YES/MAYBE, the soundwaves are/maybe sourced (e.g., reflected from) a second vehicle, method 600 can advance to step 670, whereupon other sensors/cameras, etc., can be utilized to determine/confirm whether the soundwaves are sourced from a second vehicle.

At 670, to facilitate confirmation of the source of the soundwaves is a vehicle, the analysis component can be further configured to obtain information from a vehicle component (e.g., vehicle detection component 163) configured to obtain/process additional information received from other onboard sensors, cameras, etc., (e.g., images and data-n 149A-n from cameras/sensors 148A-n) regarding whether the source of the soundwaves is indeed a vehicle.

At 680, in response to a determination (e.g., by analysis component 120) that the source of the soundwaves is NOT a vehicle, method 600 can advance to step 685, whereupon processes (e.g., process component 178 and processes 179A-n) utilized by the analysis component can be retrained/finetuned to improve the ability of the respective processes to correctly identify a vehicle (and location, motion, etc.). Method 600 can return to step 610 for subsequent transmission and processing of further soundwaves (e.g., soundwaves 150A-n).

At 680, in response to a determination (e.g., by analysis component 120) that, YES, the source of the soundwaves is another vehicle, method 600 can advance to step 690, whereupon processes (e.g., process component 178 and processes 179A-n) utilized by the analysis component can be retrained/finetuned to improve the ability of the respective processes to correctly identify a vehicle (and location, motion, etc.).

At 690, the analysis component can be further configured to generate a notification (e.g., in a communication 165A-n) of the presence of the second vehicle, wherein the analysis component can transmit the notification to a navigation component (e.g., navigation component 141).

At 695, the navigation component can be configured to adjust operation of the first vehicle in accordance with the determined operation of the second vehicle. As previously mentioned, the navigation component can be configured to control/utilize operation of various components (e.g., vehicle operation components 140, engine component 143, velocity component 144, devices component 146, cameras/sensors 148A-n) to facilitate a change in position (e.g., lane change), motion, etc., of the first vehicle. Method 600 can return to step 610 for subsequent transmission and processing of further soundwaves (e.g., soundwaves 150A-n).

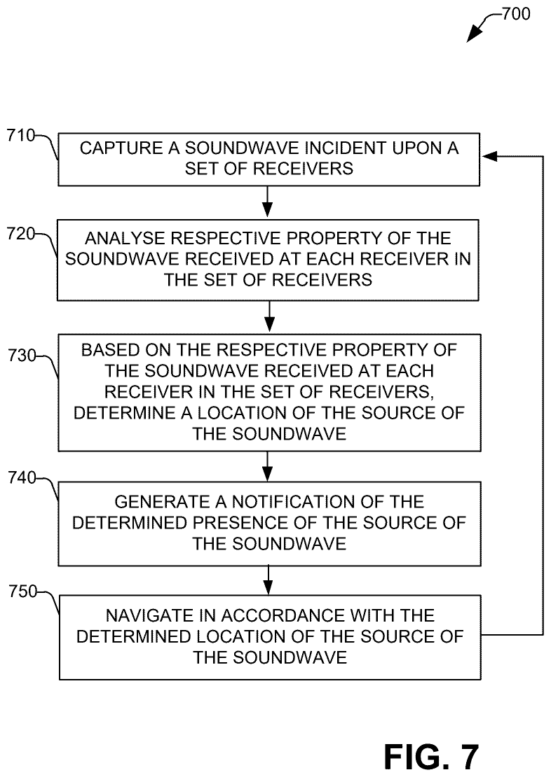

FIG. 7 illustrates a flow diagram 700 for a computer-implemented method for utilizing soundwaves to determine a position of a vehicle, in accordance with at least one embodiment.

At 710, one or more soundwaves (e.g., soundwaves 150A-n) can be received at one or more receivers (e.g., by one or more receivers 116A-n controlled by transceiver 125) located on a first vehicle (e.g., vehicle 102). In an embodiment, the one or more soundwaves (e.g., soundwaves 155A-n/156A-n) can be generated by a transmitter (e.g., transmitter 175A-n) located on a second vehicle (e.g., vehicle 170A-n) operating/located proximate to the first vehicle.

At 720, an analysis component (e.g., analysis component 120) located on the first vehicle can be configured to analyze one or more properties of the respective soundwaves received by the one or more receivers. As previously mentioned, soundwaves can be generated with respective signal strength, wavelength, frequency, pulsing, amplitude, phase, etc., to enable the analysis component to distinguish different soundwaves.

At 730, the analysis component can be further configured to, based on the previously mentioned signal analysis of the soundwaves, determine a location of the source (e.g., a transmitter 175A located/operating on vehicle 170A-n) of the soundwaves and further determine (e.g., based on triangulation of the soundwaves, and suchlike) a location of the second vehicle.

At 740, as previously mentioned, the analysis component can be further configured to generate a notification (e.g., in a communication 165A-n) of the presence of the second vehicle, wherein the analysis component can transmit the notification to a navigation component (e.g., navigation component 141).

At 750, the navigation component can be configured to adjust operation of the first vehicle in accordance with the determined operation of the second vehicle. As previously mentioned, the navigation component can be configured to control/utilize operation of various components (e.g., vehicle operation components 140, engine component 143, velocity component 144, devices component 146, cameras/sensors 148A-n) to facilitate a change in position (e.g., lane change), motion, etc., of the first vehicle. Method 700 can return to step 710 for subsequent detection/capture and processing of further soundwaves (e.g., soundwaves 150A-n).

With regard to method 700, the captured soundwaves can be generated by a transmitter (e.g., transmitter 175A) located on the second vehicle, whereby the soundwaves (e.g., soundwaves are transmitted for the purpose of determination of location of the second vehicle by the first vehicle, wherein, as previously mentioned, the soundwaves can be audible and/or inaudible. In another embodiment, the soundwaves can be generated by a siren (e.g., siren 175S), are audible to the human ear, e.g., where the second vehicle is an emergency vehicle.

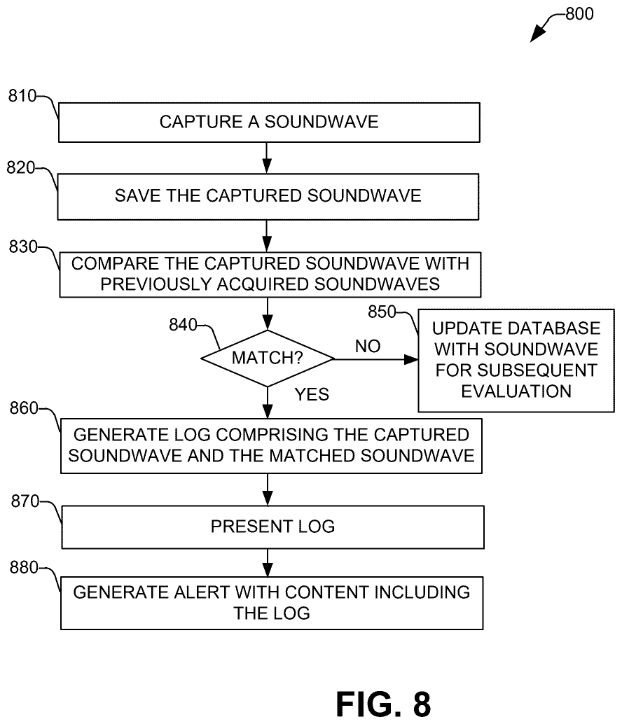

FIG. 8 illustrates a flow diagram 800 for a computer-implemented method for utilizing soundwaves to determine operation of a component/device on a vehicle, in accordance with at least one embodiment.

At 810, one or more soundwaves (e.g., soundwaves 150A-n) can be captured by a receiver (e.g., receivers 116A-n) located on a vehicle (e.g., vehicle 102). The soundwave (e.g., soundwave 153A-n) can be generated during operation of a component/device (e.g., component/device 158A-n), wherein the component/device is located on the vehicle.

At 820, the one or more soundwaves can be stored (e.g., in memory 184, historical data 189A-n) for analysis by an analysis component (e.g., analysis component 120) configured to analyze/compare the captured one or more soundwaves with other previously captured/analyzed soundwaves.

At 830, the analysis component can be configured to analyze/compare the captured one or more soundwaves with other previously captured/analyzed soundwaves (e.g., soundwaves 154A-n), whereby the previously captured/analyzed soundwaves can have identified source devices (e.g., sources/causes 158A-n) which are known to have generated the captured/analyzed soundwaves. Comparison of the captured one or more soundwaves with other previously captured/analyzed soundwaves by the analysis component can be supplemented with artificial intelligence and machine learning (AI and ML) technologies (e.g., by process component 178 and processes 179A-n), where AI/ML technologies can perform waveform comparison and suchlike to determine the component. As part of the analysis, the captured soundwave respective captured at each of the onboard receivers can be analyzed to enable determination of the location of the failing component onboard the vehicle (e.g., signal triangulation, and suchlike). For example, signal strength of the respective soundwaves can enable determination that the failing component is closer to a first receiver than a second receiver.

At 840, the analysis component can be configured to determine whether the captured soundwave (e.g., soundwave 153A) matches a previously identified soundwave (e.g., soundwave 154A-n). In response to a determination by the analysis component that NO previously identified soundwaves were found to match the captured soundwave, method 800 can advance to step 850, whereupon the captured soundwave can be saved (e.g., in memory 184 by data historian 133) for subsequent evaluation.

At 840, in response to a determination by the analysis component that YES, a previously identified soundwave was found to match the captured soundwave, method 800 can advance to step 860, whereupon an operation log (e.g., log 166A-n) can be generated comprising the captured soundwave and a previously identified soundwave(s).

At 870, content of the operation log can be presented, e.g., on an infotainment system (e.g., HMI 186 and screens 187A-n) onboard the vehicle, enabling review of the content of the operation log (e.g., by an operator of the vehicle 102, such as a driver, passenger, etc.) and subsequent action made, e.g., stop operation of the vehicle, drive vehicle to service center for repair/remediation of the component giving rise to the soundwave (e.g., soundwave 153A-n).

At 880, further, an alert (e.g., in communications 165A-n) can be generated regarding the state of the component giving rise to the soundwave, wherein the alert can be transmitted to a service center, manufacturer's central system, etc. (e.g., external system 199), enabling compilation of information regarding the failing component, scheduling service of the failing component, and suchlike.

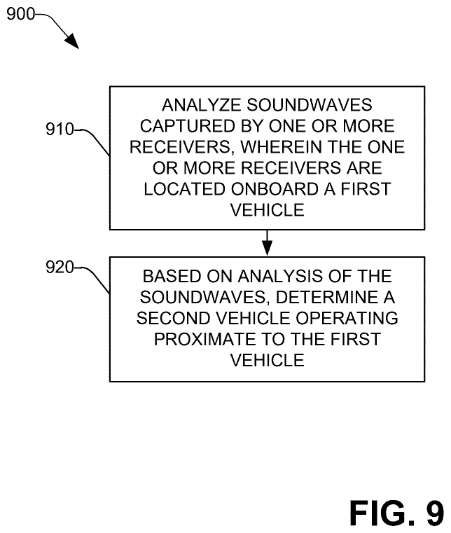

FIG. 9 illustrates a block flow diagram 900 for a method utilizing soundwaves to determine location of a second vehicle relative to a first vehicle, in accordance with one or more embodiments presented herein.

At 910, method 900 can utilize a system (e.g., SAS 110) comprising a memory (e.g., memory 184) configured to store computer executable components and a processor (e.g., processor 182) configured to execute the computer executable components stored in the memory, wherein the computer executable components include an analysis component (e.g., an analysis component 120) configured to analyze soundwaves (e.g., soundwaves 150A-n) captured by one or more receivers (e.g., receivers 116A-n), wherein the one or more receivers are co-located with the system onboard a first vehicle (e.g., vehicle 102).

At 920, the analysis component can be further configured to, based on analysis of the soundwaves, determine a second vehicle (e.g., vehicle 170A-n) operating proximate to the first vehicle.

### Application/Implementation of AI & ML

As mentioned, the various embodiments presented herein can utilize various AI/ML model/technology/technique/architecture (e.g., process component 178 implementing processes 179A-n). AI/ML technologies and techniques can be configured to determine information, make inferences, predictions, etc., regarding operation of a second vehicle 170A-n operating proximate to a first vehicle 102, and further, an operating condition of a component 158A-n located onboard the first vehicle 102.

Processes 179A-n can include AI, ML, and reasoning techniques/technologies that employ probabilistic and/or statistical-based analysis to prognose or infer an action that an entity desires to be automatically performed for carrying out various aspects thereof, e.g., determining location of a second vehicle 170A-n relative to the first vehicle 102 (enabling vehicle 102 to adjust operation), operating condition of component 158A-n, and suchlike, which as mentioned, can be facilitated via an automatic classifier system and process.

As used herein, the terms “predict”, “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events.

Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis to prognose or infer an action that a user desires to be automatically performed (e.g., determining location of a second vehicle 170A-n relative to the first vehicle 102, enabling vehicle 102 to adjust operation, an operating condition of component 158A-n, and suchlike).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (as further described below). For example, SVM's are configured via a learning or training phase within a classifier constructor and feature selection module, e.g., included in process component 178. Thus, the classifier(s) can be used to automatically learn and perform a number of functions, including but not limited to determining according to predetermined criteria, e.g., determining location of a second vehicle 170A-n, operating condition of component 158A-n, and suchlike.

In an example embodiment, processes 179A-n can be trained/fine-tuned with previously obtained/generated data (e.g., in historical data 189A-n, prior soundwaves 154A-n). Fine-tuning of a process 179A-n can comprise application, to processes 179A-n, of previously captured soundwaves 150A-n/154A-n in historical data 189A-n, analysis of the soundwaves 150A-n regarding respective frequency, wavelength, amplitude, waveform, signal pulsing, timing, timestamp, direction, signal strength, phase, and suchlike, incidence of respective soundwaves 150A-n and portions thereof on the respective receivers 116A-n (and location techniques such as signal triangulation), in conjunction with the accuracy with which a second vehicle 170A-n was detected, the location/motion of the second vehicle 170A-n, and suchlike.

Processes 179A-n can be correspondingly adjusted by the ability of the processes 179A-n (and analysis component 120) to successfully/or unsuccessfully determine the location/motion of the second vehicle 170A-n. For example, weightings in the process 179A-n are adjusted by application of the ability to accurately determine a location/motion of vehicle 170A-n/historical data 189A-n and suchlike (e.g., where accuracy of location/motion determination can be based on images/data 149A-n confirming location of the second vehicle 170A-n). During training, prior decisions, prior observations, determinations, etc., can be applied to the processes 179A-n, enabling the processes 179A-n to be trained regarding location/motion of second vehicle 170A-n, or failure of a component 158A-n. Accordingly, when new information is provided (e.g., processing of subsequent soundwaves 150A-n from a vehicle 170A-n, processing of soundwaves 150A-n resulting from an operational status of a component 158A-n), processes 179A-n can be retrained accordingly.

Accordingly, when location/motion of a second vehicle 170A-n is to be performed, analysis component 120/process component 178 can be configured to:
(a) utilize one or more pertinent processes 179A-n,
(b) apply/compare current conditions (e.g., soundwaves 150A-n, images/data 149A-n, with the prior conditions (e.g., locations, distance to, etc., of vehicle 170A-n generated from historical data 189A-n), and
(c) generate an inference/determination of location of vehicle 170A-n relative to vehicle 102 and any required operation of vehicle 102 to avoid vehicle 170A-n.

Similarly, an inference can be made by processes 179A-n regarding location of component 158A-n and soundwaves 153A-n/154A-n.

As previously mentioned, process component 178 can be utilized to implement processes 179A-n in conjunction with any of the components included in SAS 110.

It is to be appreciated that the various processes 179A-n and operations presented herein are simply examples of respective AI and ML operations and techniques, and any suitable technology can be utilized in accordance with the various embodiments presented herein. In an example embodiment, process component 178/processes 179A-n can be applied to any of soundwaves 150A-n, images/data 149A-n, determined location L₁₋ₙ, vehicle position information 172A-n, historical data 189A-n, and suchlike. Wherein, process component 178/processes 179A-n can include a vector component to apply any suitable vectoring technology, such as, in a non-limiting list, bag of words (BOW) text vectors, Euclidean distance, cosine similarity, vector representation via term frequency-inverse document frequency (tf-idf) capturing term/token frequency (e.g., common terms across prior/current/future knowledge), neural network embedding layer vector representation of terms/categories (e.g., common terms having different tense), a transformer neural network, bidirectional and auto-regressive transformer (BART) model architecture, a bidirectional encoder representation from transformers (BERT) model, long short term memory network (LSTM) operation(s), a sentence state LSTM (S-LSTM), a deep learning algorithm, a sequential neural network, a sequential neural network that enables persistent information, a recurrent neural network (RNN), a convolutional neural network (CNN), a neural network, capsule network, a machine learning algorithm, a natural language processing (NLP) technique, sentiment analysis, bidirectional LSTM (BiLSTM), stacked BiLSTM, regular pattern expression matching, and suchlike. Language models, LSTMs, BARTs, etc., can be formed with a neural network that is highly complex, for example, comprising billions of weighted parameters.

Accordingly, in an embodiment, implementation of SAS 110 and included/associated components, with processes 179A-n, enables natural language processing (NLP) (e.g., utilizing vectors) to determine a location/motion of vehicle 170A-n, wherein the determined location/motion of vehicle 170A-n can be presented on HMI 186/screen 187A-n for review, and further, for use by navigation component 141.

During application of processes 179A-n, vector representations V₁₋ₙ can be applied to any of prior and current soundwaves 150A-n, such that vector similarity operations (e.g., vector clustering/distancing) can be applied to generate a proposed location/motion of vehicle 170A-n from the accrued prior knowledge regarding prior locations/motion of vehicles 170A-n, per historical data 189A-n, vehicle position information 172A-n, and suchlike, regarding operation of vehicle 170A-n relative to vehicle 102. The degree of similarity (e.g., via similarity indexes S₁₋ₙ) between respective information can be determined, for example, based on a threshold reflecting a proximity of a first vector generated from information pertaining to a first signal strength of first soundwave 150A received at receivers 116A-n and a second vector pertaining to second signal strength of second soundwave 150B received at receivers 116B, enabling ranking of signal strengths, e.g., via vector quantization, of the first soundwave 150A, second soundwave 150B, etc., with soundwaves 150A-n in historical data-n 189A-n.

It is to be appreciated that while any of analysis component 120, transceiver component 125, vehicle operation components 140, vehicle detection component 163, communication component 160, process component 178, and suchlike, can function as separate components/implemented independently, the respective components and functionality can be combined into a single component, such as analysis component 120 operating as a single, high-level component, with one or more of transceiver component 125, vehicle operation components 140, vehicle detection component 163, communication component 160, process component 178, and suchlike.

### Example Application and Use

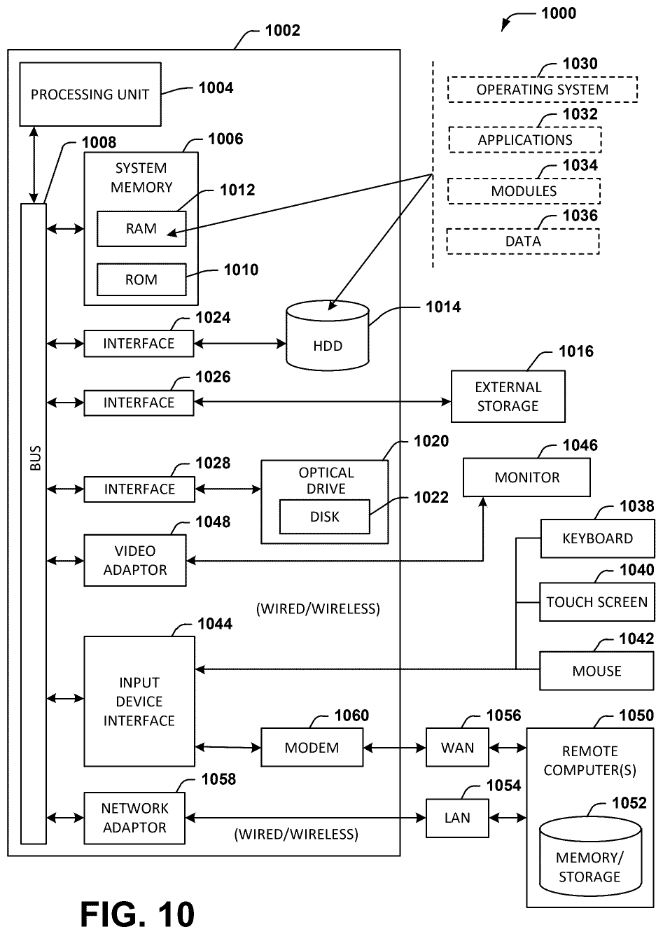

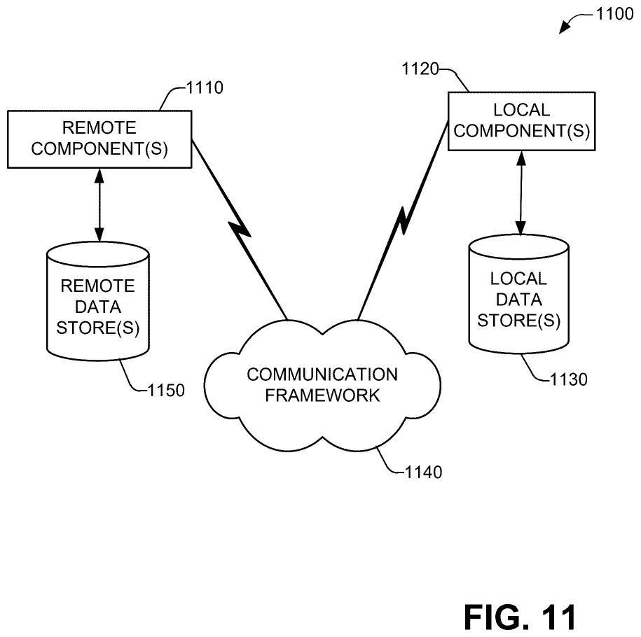

Turning next to FIGS. 10 and 11, a detailed description is provided of additional context for the one or more embodiments described herein with FIGS. 1-9 and 12.

In order to provide additional context for various embodiments described herein, FIG. 10 and the following discussion are intended to provide a brief, general description of a suitable computing environment 1000 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types.

Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

It is to be understood that when an element, component, device, etc., is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors and may include a cache memory. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the. NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can comprise a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1094 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 11, an illustrative cloud computing environment 1100 is depicted. FIG. 11 is a schematic block diagram of a computing environment 1100 with which the disclosed subject matter can interact. The system 1100 comprises one or more remote component(s) 1110. The remote component(s) 1110 can be hardware and/or software (e.g., threads, processes, computing devices). In some embodiments, remote component(s) 1110 can be a distributed computer system, connected to a local automatic scaling component and/or programs that use the resources of a distributed computer system, via communication framework 1140. Communication framework 1140 can comprise wired network devices, wireless network devices, mobile devices, wearable devices, radio access network devices, gateway devices, femtocell devices, servers, etc.

The system 1100 also comprises one or more local component(s) 1120. The local component(s) 1120 can be hardware and/or software (e.g., threads, processes, computing devices). In some embodiments, local component(s) 1120 can comprise an automatic scaling component and/or programs that communicate / use the remote resources 1110 and 1120, etc., connected to a remotely located distributed computing system via communication framework 1140.

One possible communication between a remote component(s) 1110 and a local component(s) 1120 can be in the form of a data packet adapted to be transmitted between two or more computer processes. Another possible communication between a remote component(s) 1110 and a local component(s) 1120 can be in the form of circuit-switched data adapted to be transmitted between two or more computer processes in radio time slots. The system 1100 comprises a communication framework 1140 that can be employed to facilitate communications between the remote component(s) 1110 and the local component(s) 1120, and can comprise an air interface, e.g., Uu interface of a UMTS network, via a long-term evolution (LTE) network, etc. Remote component(s) 1110 can be operably connected to one or more remote data store(s) 1150, such as a hard drive, solid state drive, SIM card, device memory, etc., that can be employed to store information on the remote component(s) 1110 side of communication framework 1140. Similarly, local component(s) 1120 can be operably connected to one or more local data store(s) 1130, that can be employed to store information on the local component(s) 1120 side of communication framework 1140.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Background, Summary, Detailed Description, and Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Various non-limiting aspects of various embodiments described herein are presented in the following clauses:
Clause 1: A system, located onboard a first vehicle, comprising: at least one processor; and a memory coupled to the at least one processor and having instructions stored thereon, wherein, in response to the at least one processor executing the instructions, the instructions facilitate performance of operations, comprising: analyzing soundwaves captured by one or more receivers, wherein the one or more receivers are located onboard the first vehicle; and based on analysis of the soundwaves, identifying a second vehicle operating proximate to the first vehicle.
Clause 2: The system of any preceding clause, wherein the system is further configured to generate initial soundwaves, wherein the soundwaves captured at the one or more receivers are reflected soundwaves generated from the initial soundwaves reflecting off a surface of the second vehicle.
Clause 3: The system of any preceding clause, wherein the initial soundwaves and reflected soundwaves are configured with an inaudible frequency.
Clause 4: The system of any preceding clause, wherein, in the event of two or more receivers are located onboard the first vehicle, the operations further comprise: determining the presence of the second vehicle based on a first reflected soundwave captured at a first receiver, a second reflected soundwave captured at a second receiver, and an n^{th} reflected soundwave captured at an n^{th} receiver; and triangulating the first reflected soundwave, the second reflected soundwave, and the n^{th} reflected soundwave.
Clause 5: The system of any preceding clause, wherein the soundwaves have an inaudible frequency and are generated by a transmitter located on the second vehicle.
Clause 6: The system of any preceding clause, wherein the soundwaves have an audible frequency and are generated by a transmitter located on the second vehicle.
Clause 7: The system of any preceding clause, wherein the first vehicle is operating autonomously while navigating a road.
Clause 8: The system of any preceding clause, wherein the operations further comprise adjusting operation of the first vehicle in accordance with operation of the second vehicle.
Clause 9: The system of any preceding clause, wherein the adjusted operation of the first vehicle comprises at least one of accelerate, reduce velocity, stop, pullover to the side of the road, or change lane.
Clause 10: The system of any preceding clause, wherein the soundwaves are included in a first set of soundwaves received at the one or more receivers, wherein the operations further comprise: analyzing a second soundwave captured by the one or more receivers; determining the second soundwave is generated by a component operating on the first vehicle; comparing the second soundwave with a previously recorded soundwave, wherein the previously recorded soundwave has an identified source component; and in the event of the second soundwave matches the previously recorded soundwave, identifying the second soundwave as being generated by the identified source component of the previously recorded soundwave.
Clause 11: A computer-implemented method comprising: analyzing, by a device comprising at least one processor and located on a first vehicle operating in at least a partially autonomous manner, a first soundwave captured by one or more receivers located on the first vehicle; and based on analysis of the first soundwave, determining, by the device, a second vehicle is operating proximate to the first vehicle.
Clause 12: The computer-implemented method of any preceding clause, wherein the first soundwave captured at the one or more receivers is a reflected soundwave, the reflected soundwave is created by an initial soundwave reflected from a surface of the second vehicle located proximate to the first vehicle, and the initial soundwave is generated by a transmitter located on the first vehicle.
Clause 13: The computer-implemented method of any preceding clause, wherein the reflected soundwave comprises an inaudible frequency.
Clause 14: The computer-implemented method of any preceding clause, wherein the first soundwave is generated by a transmitter, wherein the transmitter is located onboard the second vehicle.
Clause 15: The computer-implemented method of any preceding clause, wherein the first soundwave comprises an inaudible frequency.
Clause 16: The computer-implemented method of any preceding clause, further comprising autonomously navigating, by the device, the first vehicle in accordance with operation of the second vehicle.
Clause 17: A computer program product comprising a computer readable storage medium having program instructions embodied therewith, the program instructions executable by a processor located on a first vehicle, to cause the processor to: control transmission of a first soundwave, wherein the first soundwave is transmitted by a transmitter located onboard the first vehicle; analyze a second soundwave captured by a set of receivers located on the first vehicle, wherein the second soundwave captured at the set of receivers is a reflected soundwave, the reflected soundwave is created by reflection of the first soundwave reflected from a surface of the second vehicle located proximate to the first vehicle; and based on analysis of the second soundwave, determine a second vehicle is operating proximate to the first vehicle.
Clause 18: The computer program product of any preceding clause, wherein a frequency of the first soundwave is inaudible or audible to the human ear.
Clause 19: The computer program product of any preceding clause, wherein the first vehicle is operating autonomously.
Clause 20: The computer program product of any preceding clause, wherein a first portion of the second soundwave is received at a first receiver in the set of receivers, a second portion of the second soundwave is received at a second receiver in the set of receivers, and an n^{th} portion of the second soundwave is received at an n^{th} receiver in the set of receivers, and the program instructions further cause the processor to determine location of the second vehicle based on at least one of frequency, wavelength, amplitude, waveform, signal pulsing, timing, timestamp, direction, signal strength, or phase of the first portion of the second soundwave, second portion of the second soundwave, and the n^{th} portion of the second soundwave.

In various cases, any suitable combination of clauses 1-10 can be implemented.

In various cases, any suitable combination of clauses 11-16 can be implemented.

In various cases, any suitable combination of clauses 17-20 can be implemented.

What is claimed is:

1. A system, located onboard a first vehicle, comprising:
at least one processor; and
a memory coupled to the at least one processor and having instructions stored thereon, wherein, in response to the at least one processor executing the instructions, the instructions facilitate performance of operations, comprising:
analyzing soundwaves captured by one or more receivers, wherein the one or more receivers are located onboard the first vehicle; and
based on analysis of the soundwaves, identifying a second vehicle operating proximate to the first vehicle.

2. The system of claim 1, wherein the system is further configured to generate initial soundwaves, wherein the soundwaves captured at the one or more receivers are reflected soundwaves generated from the initial soundwaves reflecting off a surface of the second vehicle.

3. The system of claim 2, wherein the initial soundwaves and reflected soundwaves are configured with an inaudible frequency.

4. The system of claim 2, wherein, in the event of two or more receivers are located onboard the first vehicle, the operations further comprise:
determining the presence of the second vehicle based on a first reflected soundwave captured at a first receiver, a second reflected soundwave captured at a second receiver, and an n^{th} reflected soundwave captured at an n^{th} receiver; and
triangulating the first reflected soundwave, the second reflected soundwave, and the n^{th} reflected soundwave.

5. The system of claim 1, wherein the soundwaves have an inaudible frequency and are generated by a transmitter located on the second vehicle.

6. The system of claim 1, wherein the soundwaves have an audible frequency and are generated by a transmitter located on the second vehicle.

7. The system of claim 1, wherein the first vehicle is operating autonomously while navigating a road.

8. The system of claim 7, wherein the operations further comprise adjusting operation of the first vehicle in accordance with operation of the second vehicle.

9. The system of claim 8, wherein the adjusted operation of the first vehicle comprises at least one of accelerate, reduce velocity, stop, pullover to the side of the road, or change lane.

10. The system of claim 1, wherein the soundwaves are included in a first set of soundwaves received at the one or more receivers, wherein the operations further comprise:
analyzing a second soundwave captured by the one or more receivers;
determining the second soundwave is generated by a component operating on the first vehicle;
comparing the second soundwave with a previously recorded soundwave, wherein the previously recorded soundwave has an identified source component; and
in the event of the second soundwave matches the previously recorded soundwave, identifying the second soundwave as being generated by the identified source component of the previously recorded soundwave.

11. A computer-implemented method comprising:
analyzing, by a device comprising at least one processor and located on a first vehicle operating in at least a partially autonomous manner, a first soundwave captured by one or more receivers located on the first vehicle; and
based on analysis of the first soundwave, determining, by the device, a second vehicle is operating proximate to the first vehicle.

12. The computer-implemented method of claim 11, wherein the first soundwave captured at the one or more receivers is a reflected soundwave, the reflected soundwave is created by an initial soundwave reflected from a surface of the second vehicle located proximate to the first vehicle, and the initial soundwave is generated by a transmitter located on the first vehicle.

13. The computer-implemented method of claim 12, wherein the reflected soundwave comprises an inaudible frequency.

14. The computer-implemented method of claim 11, wherein the first soundwave is generated by a transmitter, wherein the transmitter is located onboard the second vehicle.

15. The computer-implemented method of claim 14, wherein the first soundwave comprises an inaudible frequency.

16. The computer-implemented method of claim 11, further comprising autonomously navigating, by the device, the first vehicle in accordance with operation of the second vehicle.

17. A computer program product comprising a computer readable storage medium having program instructions embodied therewith, the program instructions executable by a processor located on a first vehicle, to cause the processor to:
control transmission of a first soundwave, wherein the first soundwave is transmitted by a transmitter located onboard the first vehicle;
analyze a second soundwave captured by a set of receivers located on the first vehicle, wherein the second soundwave captured at the set of receivers is a reflected soundwave, the reflected soundwave is created by reflection of the first soundwave reflected from a surface of the second vehicle located proximate to the first vehicle; and
based on analysis of the second soundwave, determine a second vehicle is operating proximate to the first vehicle.

18. The computer program product of claim 17, wherein a frequency of the first soundwave is inaudible or audible to the human ear.

19. The computer program product of claim 17, wherein the first vehicle is operating autonomously.

20. The computer program product of claim 17, wherein a first portion of the second soundwave is received at a first receiver in the set of receivers, a second portion of the second soundwave is received at a second receiver in the set of receivers, and an n^{th} portion of the second soundwave is received at an n^{th} receiver in the set of receivers, and the program instructions further cause the processor to determine location of the second vehicle based on at least one of frequency, wavelength, amplitude, waveform, signal pulsing, timing, timestamp, direction, signal strength, or phase of the first portion of the second soundwave, second portion of the second soundwave, and the n^{th} portion of the second soundwave.
